(19) United States
(12) Patent Application Publication
(10) Pub. No.: US 2008/0295097 A1
(43) Pub. Date: Nov. 27, 2008

(54) Techniques for sharing resources among multiple devices in a processor system

(75) Inventor: Andrej Kocev, York, ME (US)

Correspondence Address: LARSON NEWMAN ABEL POLANSKY & WHITE, LLP, 5914 WEST COURTYARD DRIVE, SUITE 200, AUSTIN, TX, 78730, US

(73) Assignee: ADVANCED MICRO DEVICES, INC., Sunnyvale, CA (US)

(21) Appl. No.: 11/753,355

(22) Filed: May 24, 2007

(51) Int. Cl. G06F 9/46

(52) U.S. Cl. 718/100

(57) ABSTRACT

A technique of shared resource handling for multiple devices includes determining a first lifetime of a first transaction associated with an active first device, included within the multiple devices. The technique also includes assigning at least a portion of a first system resource to the active first device for use in the first transaction, when the first lifetime corresponds to a long-lifetime. Finally, the technique includes assigning at least a portion of a second system resource to the active first device for use in the first transaction, when the first lifetime corresponds to a short-lifetime. In this case, the second system resource was previously reserved to one or more inactive second devices, included within the multiple devices.

### BACKGROUND

1. Field of the Disclosure

The present disclosure is generally directed to processor system and, more particularly, to techniques for sharing resources among multiple devices in a processor system.

2. Description of the Related Art

Various systems/subsystems employ the concept of virtual channels to a share a system/subsystem resource. For example, a host bridge may utilize a shared memory for virtual channels to act as an interface when transferring information between a central processing unit (CPU) and input/output (I/O) devices coupled to an I/O link. In a typical implementation, each device has been assigned one or more buffers, which are included within the shared memory. For example, in at least one conventional processor system, buffers in a shared memory have been statically assigned. In this case, when one of the devices is inactive, the buffers assigned to the inactive device are unused. In another conventional processor system, one or more buffers within a shared memory have been assigned to each device in the system and unassigned buffers have been assigned to a free-pool. In this case, when one of the devices required additional buffers, the device requested the additional buffers from the free-pool. While the free-pool scheme is more efficient than static assignment, buffers statically allocated to inactive devices are still not available to active devices.

What is needed is an improved technique for more efficiently sharing resources among devices in a processor system.

### BRIEF DESCRIPTION OF THE DRAWINGS

The present disclosure may be better understood, and its numerous features and advantages made apparent to those skilled in the art by referencing the accompanying drawings.

FIG. 1 shows an example electrical block diagram of a processor system that may be configured according to various embodiments of the present disclosure.

FIG. 2 shows an example flow chart of a process for sharing resources among multiple devices in a processor system according to one embodiment of the present disclosure.

FIG. 3 shows an example flow chart of a process for sharing resources among multiple devices in a processor system according to another embodiment of the present disclosure.

The use of the same reference symbols in different drawings indicates similar or identical items.

### DESCRIPTION OF THE PREFERRED EMBODIMENT(S)

The techniques disclosed herein generally facilitate better utilization of a shared resource, e.g., a shared memory, among devices (e.g., one or more central processing units (CPUs), one or more input/output (I/O) virtual channels, or other system components that are capable of generating system operations (e.g., reads/writes to memory, I/O, etc.)). For example, in one embodiment, when an active device requires a shared resource to perform a transaction, the entire shared resource may be assigned to the active device, assuming that other devices that utilize the shared resource are inactive and a lifetime of an associated transaction corresponds to a short-lifetime transaction. It should be appreciated that the techniques disclosed herein may be broadly applicable to a wide variety of systems (or subsystems) that implement interfaces with virtual channels. For example, it is contemplated that the techniques disclosed herein may be employed in computer systems, switches, bridges, etc.

In general, a lifetime of a transaction that uses a shared resource may be classified as a short-lifetime transaction or a long-lifetime transaction, where a request-type, traffic-type, etc., may be used to distinguish between the types of transactions. In the event that a lifetime of a particular transaction cannot be readily ascertained, the particular transaction may be treated as a long-lifetime transaction to reduce the occurrence of a transaction utilizing a disproportionate share of the shared resource. For example, a read from or a write to (e.g., by a central processing unit (CPU) or an I/O device) a main memory (e.g., a dynamic random access memory (DRAM)) may be classified as a short-lifetime transaction. As another example, a read from or a write to a hard-drive (e.g., by a CPU) may be classified as a long-lifetime transaction. As yet another example, a read from or a write to an I/O port (e.g., by a CPU) may be classified as a long-lifetime transaction. As used herein, the term “coupled” includes both a direct electrical connection between elements (or blocks) and an indirect electrical connection between elements (or blocks) provided by one or more intervening elements (or blocks).

According to one embodiment of the present disclosure, a technique of shared resource handling for multiple devices includes determining a first lifetime of a first transaction associated with an active first device, included within the multiple devices. The technique also includes assigning at least a portion of a first system resource (e.g., one or more elements of a shared memory that are reserved for the active first device and one or more elements of the shared memory that are assigned to a free-pool) to the active first device for use in the first transaction, when the first lifetime corresponds to a long-lifetime. Finally, the technique includes assigning at least a portion of a second system resource (e.g., one or more elements of the shared memory that are reserved for other inactive devices) to the active first device for use in the first transaction, when the first lifetime corresponds to a short-lifetime. According to this aspect of the present disclosure, the second system resource was previously reserved to one or more inactive second devices, included within the multiple devices.

According to another embodiment of the present disclosure, a processing system includes multiple devices, a shared system resource, and a resource controller. The multiple devices include an active first device and one or more inactive second devices. The shared system resource is coupled to the multiple devices and the resource controller is coupled to the shared system resource and the multiple devices. The resource controller is configured to determine a first lifetime of a first transaction associated with the active first device. The resource controller is also configured to assign at least a portion of a first system resource (e.g., one or more elements of a shared memory that are reserved for the active first device and one or more elements of the shared memory that are assigned to a free-pool), included within the shared system resource, to the active first device for use in the first transaction when the first lifetime corresponds to a long-lifetime. Finally, the resource controller is configured to assign at least a portion of a second system resource (e.g., one or more elements of the shared memory that are reserved for other inactive devices), included within the shared system resource, to the active first device for use in the first transaction when the first lifetime corresponds to a short-lifetime. According to this aspect, the second system resource was previously reserved to the one or more inactive second devices.

According to another aspect of the present disclosure, a computer system includes multiple devices, a shared memory, and a memory controller. The multiple devices including an active first device and one or more inactive second devices. The shared memory is coupled to the multiple devices. The memory controller is coupled to the shared memory and the multiple devices. The memory controller is configured to determine a first lifetime of a first transaction associated with the active first device. The memory controller is also configured to assign at least a portion of a first buffer, included within the shared memory, to the active first device for use in the first transaction, when the first lifetime corresponds to a long-lifetime. The memory controller is further configured to assign at least a portion of a second buffer, included within the shared memory, to the active first device for use in the first transaction, when the first lifetime corresponds to a short-lifetime. According to this aspect, the second buffer was previously reserved to the one or more inactive second devices.

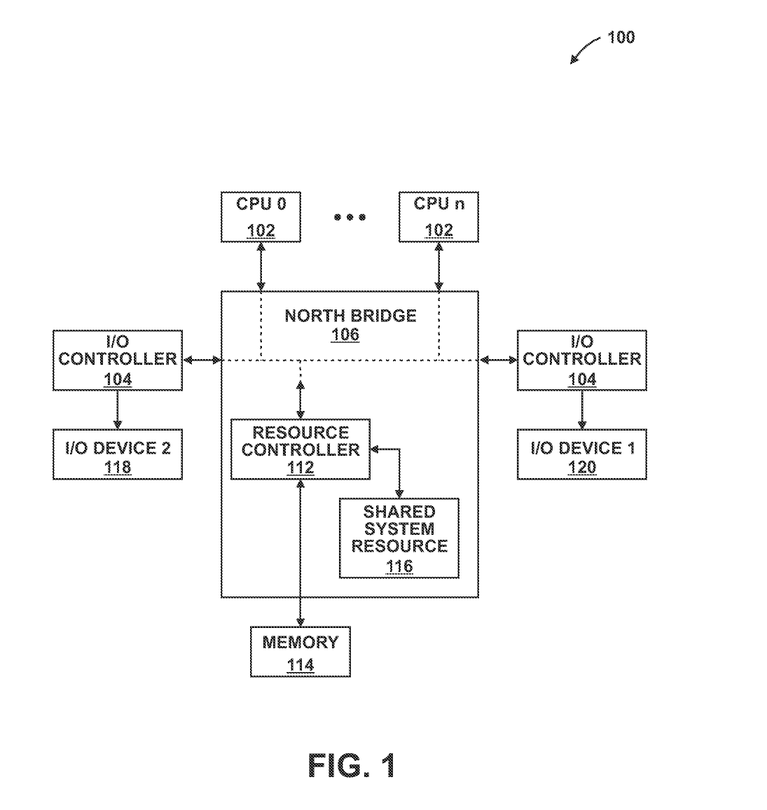

With reference to FIG. 1, an example processor system 100 is illustrated that includes multiple central processing units (CPUs) 102, multiple input/output (I/O) controllers 104, a Northbridge 106, a resource controller 112, and a memory 114. The system 100 also includes an I/O device 118 coupled to one of the I/O controllers 104 and an I/O device 120 coupled to another of the I/O controllers 104, denoted as I/O device 2 and I/O device 1, respectively. The I/O devices 118 and 120 may be, for example, a hard-drive, an I/O port, a network device, a keyboard, a mouse, a graphics card, etc. As is shown, a shared system resource 116, e.g., a shared memory, is coupled to the resource controller 112, e.g., a memory controller. While only two of the CPUs 102 are depicted in FIG. 1, it should be appreciated that the techniques disclosed herein are broadly applicable to processor systems that include more or less that two CPUs, each of which may have one or more levels of internal cache. Similarly, while only two I/O controllers 104 are depicted in FIG. 1, it should be appreciated that the techniques disclosed herein are broadly applicable to processor systems that include more or less that two I/O controllers.

The resource controller 112 may be, for example, a dynamic random access memory (DRAM) controller and, in this case, the memory 114 includes multiple DRAM modules. As is illustrated, the resource controller 112 is integrated within the Northbridge 106 with the shared system resource 116. It should, however, be appreciated the resource controller 112 and the shared system resource may be located in different respective functional blocks of the processor system 100. The I/O controllers 104 may take various forms. For example, the I/O controllers 104 may be HyperTransport™ controllers. In general, the system 100 includes various devices that read/write information from/to the memory 114. The various devices may, for example, utilize the shared system resource 116 as an in-flight queue (IFQ) when reading/writing information from/to the memory 114.

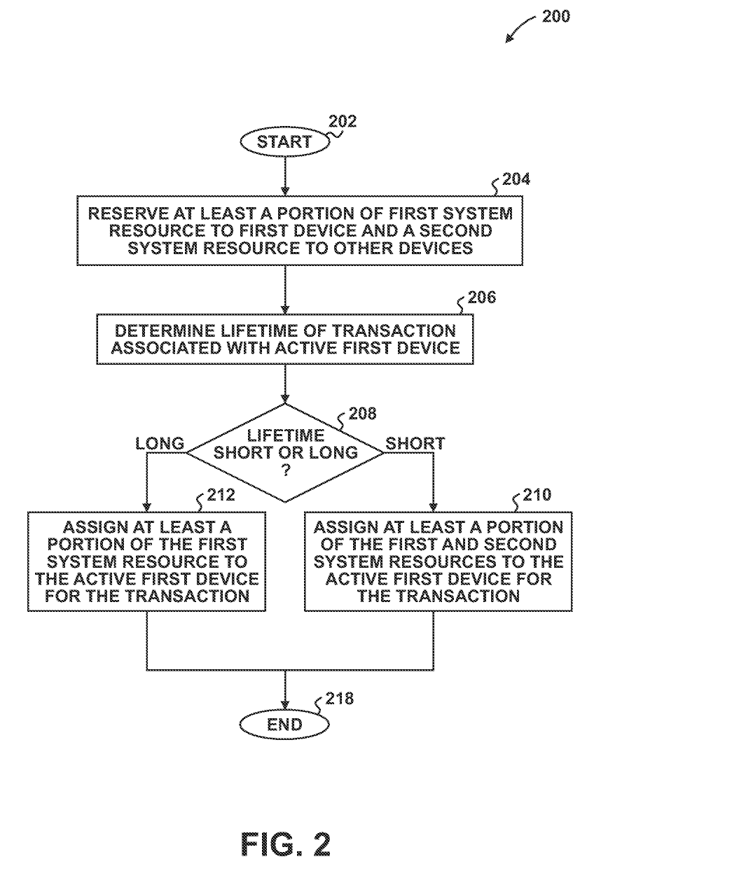

With reference to FIG. 2, an example process 200 for sharing resources among multiple devices associated with a processor system, according to various embodiments of the present disclosure, is illustrated. In block 202, the process 200 is initiated, at which point control transfers to block 204, where at least a portion of a first system resource (e.g., a portion of a shared memory that acts as an in-flight queue (IFQ)) is reserved to an active first device (e.g., one of the CPUs 102) and a second system resource (e.g., a different portion of the shared memory) is assigned to other devices associated with the processor system 100.

Control then transfers to block 206 when the active first device requires a resource to perform a transaction. The lifetime of a transaction associated with the active first device is determined by, for example, the resource controller 112. The determination of the lifetime of the transaction may be based upon the request type, traffic type, etc. Then, in block 208, based on the lifetime of the transaction, a resource is assigned. When the transaction is a long-lifetime transaction, control transfers from block 208 to block 212, where at least a portion of the first system resource is assigned to the active first device for the transaction.

When the transaction is a short-lifetime transaction, control transfers from block 208 to block 210, where at least a portion of the first system resource and at least a portion of the second system resource are assigned to the active first device for the transaction. In this case, the portion of the first system resource assigned to the active first device may correspond to buffers allocated to the first device and one or more buffers allocated to a free-pool and the at least a portion of the second system resource may correspond to buffers allocated to various inactive devices. Following blocks 210 and 212 control transfers to block 218, where the process 200 terminates.

In general, the techniques disclosed herein are broadly applicable to a system or subsystem that includes a set of resources (R1 . . . Rn, where there are ‘n’ total resources) and a set of devices (D1 . . . Dm, where there are ‘m’ total devices). The devices may represent CPUs, I/O virtual channels, or any other system component that is capable of generating system operations (e.g., reads/writes from/to memory, I/O, etc). For example, a system may include six devices D1-D6 configured as follows: D1 corresponds to CPU 0; D2 corresponds to CPU 1; D3 corresponds to I/O virtual channel A; D4 corresponds to I/O virtual channel B; D5 corresponds to I/O virtual channel C; and D6 corresponds to an interrupt controller. In general, a set of resources can be thought of as a set of identical discrete resource elements (Rj), each of which can be assigned to only one device at a time. As such, a resource element (Rj) can be in one of three states: idle (i.e., unassigned); short-lifetime (assigned for a short-lifetime operation); or long-lifetime (assigned for a long-lifetime operation).

In at least one embodiment, the technique may be implemented using constants and counters that are tracked by a resource controller, which determines how to assign the resources. In this embodiment, the constants are static values assigned by configuration software, tuned for best performance, and are defined as follows: Max(FP) is a static number that represents the number of resources in a free-pool (where any device Di can be assigned a resource from the free-pool); Max(Di) is a static number that represents the number of resources that are reserved for use by device Di. According to this embodiment, the resource controller employs the following counters: NumLL(Di), which corresponds to a counter that represents the number of resources assigned to device Di for long-lifetime operations; ExcessLL(Di), which corresponds to NumLL(Di)−Max(Di) (but not less than zero); and SumOfExcesses, which corresponds to ExcessLL(D0)+ExcessLL(D1)+ . . . +ExcessLL(Dm). According to the prior art techniques discussed above, at any one time at most Max(Di)+Max(FP) resources can be assigned to device Di. In this case, Max(FP)+Max(D0)+Max(D1)+Max(D2)+ . . . +Max(Dm) is equal to the size of the total set of resources.

According to the techniques disclosed herein, the NumLL(Di) counter starts at zero and is incremented whenever a resource is assigned to device Di for a long-lifetime operation and is decremented when either a long-lifetime operation completes, or when a long-lifetime operation becomes a short-lifetime operation. It should be appreciated that when a long-lifetime operation become a short-lifetime operation is implementation specific. According to one embodiment, pseudo code for implementing decision flow for a resource controller when an active device Di is in need of a resource Rj may be implemented as follows:

```
IF (Resource Rj Available)
THEN IF (short-lifetime operation)
  THEN [Assign Rj to Di for short-lifetime operation]
  ELSE IF (NumLL(Di) < Max(Di) OR SumOfExcesses < Max(FP))
    THEN [Assign Rj to Di for long-lifetime operation]
    ELSE [Do nothing; Go back and try again later]
ELSE  [Do nothing; Go back and wait for a resource to become
available]
```

According to the above technique, the resource controller may assign all resources to an active device Di, provided that the device Di requires the use of all the resources and the other devices are inactive, and at least some of the operations that device Di is performing are short-lifetime operations. Similarly, if only a subset of the devices are active and all other devices are inactive, all resources may be assigned to the active devices.

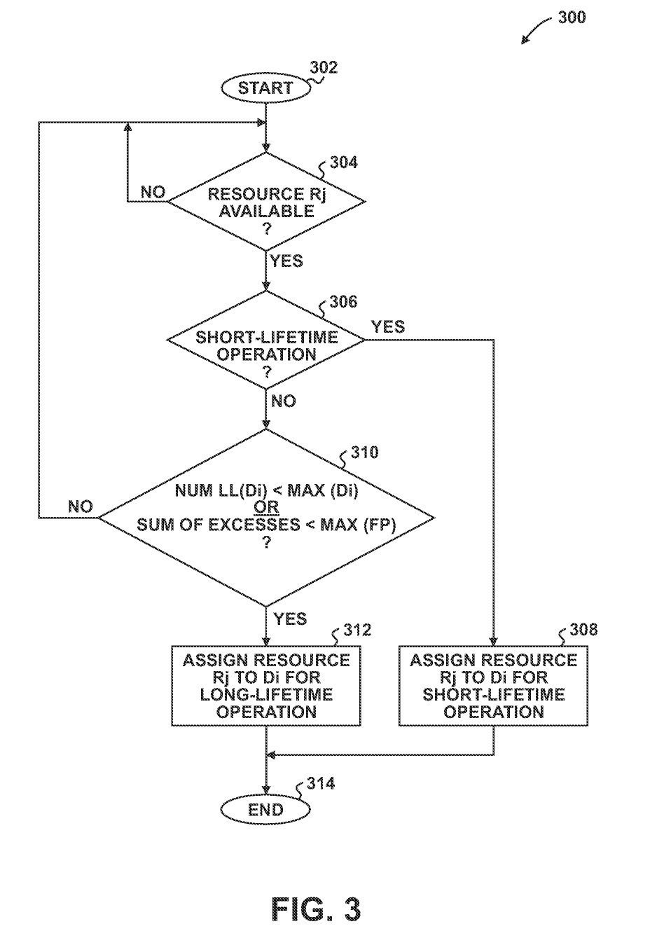

With reference to FIG. 3, an example process 300 for assigning resources to a device is illustrated. The process 300 may, for example, be implemented by the resource controller 112. In block 302, the process 300 is initiated at which point control transfers to decision block 304. In block 304, the resource controller 112 determines whether a resource Rj is available for assignment to device Di. If a resource is not available, control loops on block 304 until a resource is available for assignment to device Di. Next, in decision block 306, the resource controller determines whether the operation that requires a resource is a short-lifetime operation. If the operation is a short-lifetime operation, control transfers from block 306 to block 308, where resource Rj is assigned to device Di for the short-lifetime operation.

Following block 308, control transfers to block 314, where control returns to a calling process. In block 306, when the operation is a long-lifetime operation, control transfers to decision block 310. In block 310, the resource controller 112 determines whether the number of long-lifetime operations for device Di is less than the static resources assigned to device Di (NumLL(Di)<Max(Di)) or if the sum of all numbers of long-lifetime operations in excess of the reserved count for each device is less than the number of resources assigned to a free-pool (SumOfExcesses<Max(FP)). If the condition is satisfied in block 310, control transfers from block 310 to block 312, where resource Rj is assigned to device Di for the long-lifetime operation. Following block 312, control transfers to block 314. If the condition is not satisfied in block 310, control transfers from block 310 to block 304.

Accordingly, techniques have been described herein that facilitate resource sharing among devices in a relatively straight forward efficient manner. While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing the exemplary embodiment or exemplary embodiments. It should be understood that various changes can be made in the function and arrangement of elements without departing from the scope of the invention as set forth in the appended claims and the legal equivalents thereof.

What is claimed is:

1. A method of shared resource handling for multiple devices, comprising:
determining a first lifetime of a first transaction associated with an active first device, included within the multiple devices;
assigning at least a portion of a first system resource to the active first device for use in the first transaction when the first lifetime corresponds to a long-lifetime; and
assigning at least a portion of a second system resource to the active first device for use in the first transaction when the first lifetime corresponds to a short-lifetime, wherein the second system resource was previously reserved to one or more inactive second devices, included within the multiple devices.

2. The method of claim 1, wherein the first system resource includes a reserved system resource that was previously reserved for the active first device.

3. The method of claim 2, wherein the first system resource includes an unreserved system resource that was not previously reserved for any of the multiple devices.

4. The method of claim 1, further comprising:
initially reserving the at least a portion of a first system resource to the active first device and the second system resource to remaining ones of the multiple devices.

5. The method of claim 1, wherein the multiple devices include one or more input/output devices and one or more central processing units.

6. The method of claim 1, wherein the first and second system resources each correspond to one or more buffers.

7. The method of claim 1, wherein the active first device is a central processing unit and the first transaction corresponds to a read or a write to main memory.

8. The method of claim 1, wherein the active first device is a central processing unit and the first transaction corresponds to a read or a write to a hard-drive.

9. The method of claim 1, wherein the active first device is a central processing unit and the first transaction corresponds to a read or a write to an input/output device.

10. The method of claim 1, wherein the active first device is an input/output device and the first transaction corresponds to a read or a write to main memory or a read or a write to an input/output device.

11. A processing system, comprising:
multiple devices including an active first device and one or more inactive second devices;
a shared system resource coupled to the multiple devices; and
a resource controller coupled to the shared system resource and the multiple devices, wherein the resource controller is configured to:
determine a first lifetime of a first transaction associated with the active first device;
assign at least a portion of a first system resource, included within the shared system resource, to the active first device for use in the first transaction when the first lifetime corresponds to a long-lifetime; and
assign at least a portion of a second system resource, included within the shared system resource, to the active first device for use in the first transaction when the first lifetime corresponds to a short-lifetime, wherein the second system resource was previously reserved to the one or more inactive second devices.

12. The processing system of claim 11, wherein the first system resource includes a reserved system resource that was previously reserved for the active first device.

13. The processing system of claim 12, wherein the first system resource includes an unreserved system resource that was not previously reserved for any of the multiple devices.

14. The processing system of claim 11, wherein the multiple devices include one or more input/output devices and one or more central processing units.

15. The processing system of claim 11, wherein the shared system resource corresponds to a memory and the resource controller is includes within a Northbridge circuit.

16. The processing system of claim 11, wherein the active first device is a central processing unit or an input/output device and the first transaction corresponds to a read or a write to main memory or a read or a write to an input/output device.

17. A computer system, comprising:
multiple devices including an active first device and one or more inactive second devices;
a shared memory coupled to the multiple devices; and
a memory controller coupled to the shared memory and the multiple devices, wherein the memory controller is configured to:
determine a first lifetime of a first transaction associated with the active first device;
assign at least a portion of a first buffer, included within the shared memory, to the active first device for use in the first transaction when the first lifetime corresponds to a long-lifetime; and
assign at least a portion of a second buffer, included within the shared memory, to the active first device for use in the first transaction when the first lifetime corresponds to a short-lifetime, wherein the second system buffer was previously reserved to the one or more inactive second devices.

18. The computer system of claim 17, wherein the first buffer includes a reserved buffer and the memory controller is further configured to:
receive a first request, associated with the first transaction, from the active first device; and
assign the reserved buffer to the active first device for use in the first transaction responsive to the first request, wherein the reserved buffer was previously reserved for the active first device.

19. The computer system of claim 18, wherein the first buffer includes an unreserved buffer and the memory controller is further configured to:
assign the unreserved buffer to the active first device for use in the first transaction responsive to the first request, wherein the unreserved buffer was not previously reserved for any of the multiple devices.

20. The computer system of claim 19, wherein the active first device is an input/output device or a central processing unit and the first transaction corresponds to a read or a write to main memory or a read or a write to an input/output device.
